(19) United States
(12) Patent Application Publication
(10) Pub. No.: US 2009/0285310 A1
(43) Pub. Date: Nov. 19, 2009

(54) RECEIVING APPARATUS, RECEIVING METHOD, PROGRAM AND COMMUNICATION SYSTEM

(76) Inventors: Hideki Iwami, Saitama (JP); Kazuhisa Hosaka, Tokyo (JP); Satoshi Futenma, Tokyo (JP); Naoto Nishimura, Kanagawa (JP); Hiroshi Akinaga, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/465,479

(22) Filed: May 13, 2009

(30) Foreign Application Priority Data
May 16, 2008 (JP) P2008-129852

(51) Int. Cl. H04N 7/26

(52) U.S. Cl. 375/240.25; 375/E07.027

(57) ABSTRACT

There is provided a receiving apparatus including a header detection section that receives image data encoded per a coding unit corresponding to N (N is equal to or greater than 1) lines in one field and detects control information to decide a decoding start point of the image data from a header attached to the image data, a storage section that stores the image data in each storage area assigned per the coding unit, a decoding start instruction section that decides a decoding start point of the image data based on the control information detected by the header detection section and, after waiting till the decoding start point, instructs a start of decoding per the coding unit, and a decoding section that decodes the image data stored in the storage section per the coding unit after the instruction to start decoding being received from the decoding start instruction section.

### BACKGROUND OF THE INVENTION

1. Field of the Invention

The present invention relates to a receiving apparatus, a receiving method, a program, and a communication system.

2. Description of the Related Art

Currently, applications and services to transfer image data (particularly moving image data) via various networks such as the Internet and a LAN (Local Area Network) are widely used. When image data is transmitted via a network, generally the amount of data is reduced by coding (compression) process on the transmitting side before the data being sent out to a network and decoding (decompression) processing is performed on received encoded data on the receiving side before the data being reproduced.

For example, a compression technology called MPEG (Moving Pictures Experts Group) is available as one of the most known techniques of image compression processing. When the MPEG compression technology is used, an MPEG stream generated based on the MPEG compression technology is stored in IP packets according to IP (Internet Protocol) for delivery via a network. Then, the MPEG stream is received by using a communication terminal such as a PC (Personal Computer), PDA (Personal Digital Assistants) or mobile phone and displayed on a screen of each terminal.

Under such circumstances, it is necessary to assume that image data is received by terminals having different capabilities in applications intended mainly for delivery of image data, for example, video on-demands, live image delivery, video conferencing, and videophones.

For example, there is a possibility that image data transmitted from one transmission source is received and displayed by a receiving terminal having a display with low resolution and a CPU with low processing capabilities such as a mobile phone. At the same time, there is a possibility that image data is received and displayed by a receiving terminal having a high-resolution monitor and a high-performance processor such as a desktop PC.

When it is assumed, as described above, that image data is received by receiving terminals having different performance, for example, a technology called hierarchical coding that hierarchically performs coding of data to be transmitted/received is used. Hierarchically encoded image data distinctly holds, for example, encoded data for a receiving terminal having a high-resolution display and encoded data for a receiving terminal having a low-resolution display so that the image size and image quality can be appropriately changed on the receiving side.

Compression/decompression technologies that can perform hierarchical coding include, for example, MPEG4 and JPEG2000. FGS (Fine Granularity Scalability) technology is scheduled to be incorporated into MPEG4 and profiled as a standard technology and it is said that the hierarchical coding technology will be able to scalably deliver low bit rates to high bit rates. In JPEG2000 based on wavelet conversion, it is possible to generate packets based on spatial resolution by making use of features of wavelet conversion or generate packets hierarchically based on image quality. JPEG2000 can also store hierarchized data in a file format based on Motion JPEG2000 (Part 3) capable of handling not only static images, but also moving images.

Further, there is a scheme based on a discrete cosine transform (DCT) proposed as a concrete scheme of data communication to which hierarchical coding is applied. This is a method by which DCT processing is performed on a communication target, for example, image data to realize hierarchization of the image data by distinguishing high frequencies and low frequencies through DCT processing and packets separated by the hierarchy of high frequency area and low frequency area are generated to perform data communication.

When such hierarchically encoded image data is delivered, real-time properties are in most cases demanded, but under current circumstances, there is a trend that a big-screen/high-quality display takes precedence over real-time properties.

To guarantee real-time properties for delivery of image data, the UDP (User Datagram Protocol) is usually used as an IP-based communication protocol. Further, the RTP (Real-Time Transport Protocol) is used in a layer over the UDP. Data stored in RTP packets follows a format defined individually for each application, that is, each coding mode.

Communication methods such as a wireless or wired LAN, optical fiber communication, xDSL, power line communication, and Co-ax are used for a communication network. These communication methods achieve higher transmission speed year by year with increasingly higher quality image contents thereby transmitted.

For example, the code delay (coding delay+decoding delay) of a typical system in the currently mainstream MPEG system or JPEG2000 system is two pictures or more and thus, it can hardly be said that sufficient real-time properties for image data delivery are guaranteed.

Therefore, in these days, a proposal of an image compression technology that reduces the delay time by dividing one picture into a set of N lines (N is equal to or greater than 1) and coding the image per unit of the divided set (called a line block) is beginning to appear (hereinafter, such technology is referred to as a line-based codec). Advantages of the line-based codec include being able to achieve high-speed processing and reduction in hardware scale because the amount of information processed in one unit of image compression is smaller, in addition to a short delay.

Examples of research on the line-based codec in the past include the followings. That is, Japanese Patent Application Laid-Open No. 2007-311948 describes a communication apparatus that performs complementation processing of missing data for each line block of communication data based on the line-based codec. Japanese Patent Application Laid-Open No. 2008-28541. describes an information processing apparatus designed to reduce the delay and make processing efficient when the line-based codec is used. Japanese Patent Application Laid-Open No. 2008-42222 describes transmitting apparatus that suppresses image quality deterioration by transmitting low-frequency components of lined-based wavelet converted image data.

### SUMMARY OF THE INVENTION

However, the image compression technology by the line-based codec still has some technically unresolved issues. One of such issues is an issue about synchronization between transmitting and receiving terminals.

Generally, in the picture-based codec, reproduction processing per unit of picture or frame is performed using time stamp inserted into the header of a packet, a horizontal synchronization signal (VSYNC) or vertical synchronization signal (HSYNC), and SAV (Start of Active Video) and EAV (End of Active Video) which are known as signals added to the start and end of a blank period respectively. Thus, decoding can be performed on the receiving side with relatively sufficient time lead by starting decoding after one frame at the shortest with reference to the synchronization signal and the known signals.

In the line-based codec, in contrast, the coding unit time is shorter than that of the picture-based codec and thus, the time available for control of transmission and reception becomes necessarily shorter than that available for the picture-based codec.

Moreover, if an image pattern that is difficult to encode is involved in the coding unit, the data may temporarily be stored in a transmission buffer because the amount of data temporarily increases and all compressed data can be hardly sent out to a transmission path. In such a case, a situation occurs in which the transmission output timing is delayed from the time at which transmission should occur. Then, if the transmission output timing is delayed from the time at which transmission should occur, it is difficult for the receiving side to determine the time to start decoding. Thus, also in the line-based codec, a technique of being able to determine the timing to start decoding steadily and easily is demanded while making use of an advantage of a short delay.

Thus, it is desirable to provide a new and improved receiving apparatus, receiving method, program, and communication system capable of steadily acquiring synchronization in communication using a line-based codec.

According to an embodiment of the present invention, there is provided a receiving apparatus including a header detection section that receives image data encoded per a coding unit corresponding to N (N is equal to or greater than 1) lines in one field and detects control information to decide a decoding start point of the image data from a header attached to the image data, a storage section that stores the image data in each storage area assigned per the coding unit, a decoding start instruction section that decides a decoding start point of the image data based on the control information detected by the header detection section and, after waiting till the decoding start point, instructs a start of decoding per the coding unit, and a decoding section that decodes the image data stored in the storage section per the coding unit after the instruction to start decoding being received from the decoding start instruction section.

According to the above configuration, the header detection section receives image data encoded per a coding unit corresponding to N (N is equal to or greater than 1) lines in one field and detects control information to decide a decoding start point of the image data from a header attached to the image data. Then, the storage section stores the image data in each storage area assigned per the coding unit. Then, the decoding start instruction section decides a decoding start point of the image data based on the control information detected by the header detection section and, after waiting till the decoding start point, instructs a start of decoding per the coding unit. Then, decoding section decodes the image data stored in the storage section per the coding unit after the instruction to start decoding being received from the decoding start instruction section.

The header detection section may include a first header detection section that detects a first time stamp corresponding to a data transmission point from a communication header attached to the image data and a second header detection section that detects a second time stamp corresponding to a coding point from an image header attached to the image data.

In this case, the decoding start instruction section may adjust the decoding start point in accordance with a time difference between the first time stamp and the second time stamp detected by the header detection section.

The decoding start instruction section may sequentially measure a permissible decoding time for each coding unit from the decoding start point to instruct a start of decoding per the coding unit each time the permissible decoding time passes.

If reception of image data to be decoded per the coding unit is not completed, the decoding start instruction section may insert dummy data instead of the image data whose reception is not completed.

In this case, the dummy data may be image data of a previous picture or a picture prior to the previous picture in a line or line block identical to that of the image data to be decoded.

If image data to be decoded remains when the permissible decoding time per the coding unit ends, the decoding start instruction section may delete the image data to be decoded.

The decoding start instruction section may decide a point when a predetermined time passes after control information indicating that a head of a picture has been recognized being output by the header detection section as the decoding start point.

The receiving apparatus may further include a synchronization control section that transmits a signal to designate a transmission start time of the image data to a source apparatus of the image data.

The synchronization control section may designate a decoding start time having a time interval to absorb fluctuations of a communication environment between the transmission start time and the decoding start time for the decoding start instruction section, and the decoding start instruction section may decide the decoding start point based on the designated decoding start time.

The header detection section may include a first header detection section that detects a first time stamp corresponding to a data transmission point from a communication header attached to the image data and a second header detection section that detects a second time stamp corresponding to a coding point from an image header attached to the image data, and the decoding start instruction section may decide, based on switching information for switching processing to be performed, a point when a predetermined time passes after control information indicating that a head of a picture has been recognized being output by the header detection section as the decoding start point or adjust the decoding start point in accordance with a time difference between the first time stamp and the second time stamp detected by the header detection section.

The receiving apparatus may further include a synchronization control section that transmits a signal to designate a transmission start time of the image data to a source apparatus of the image data and designates a decoding start time having a time interval to absorb fluctuations of a communication environment between the transmission start time and the decoding start time for the decoding start instruction section, wherein the decoding start instruction section may decide, based on switching information for switching processing to be performed, a point when a predetermined time passes after control information indicating that a head of a picture has been recognized being output by the header detection section as the decoding start point or decide the decoding start point based on the decoding start time designated by the synchronization control section.

The receiving apparatus may further include a synchronization control section that transmits a signal to designate a transmission start time of the image data to a source apparatus of the image data and designates a decoding start time having a time interval to absorb fluctuations of a communication environment between the transmission start time and the decoding start time for the decoding start instruction section, wherein the header detection section may include a first header detection section that detects a first time stamp corresponding to a data transmission point from a communication header attached to the image data and a second header detection section that detects a second time stamp corresponding to a coding point from an image header attached to the image data and the decoding start instruction section may adjust, based on switching information for switching processing to be performed, the decoding start point in accordance with a time difference between the first time stamp and the second time stamp detected by the header detection section or decide the decoding start point based on the decoding start time designated by the synchronization control section.

According to another embodiment of the present invention, there is provided a receiving method, including the steps of: receiving image data encoded per a coding unit corresponding to N (N is equal to or greater than 1) lines in one field; detecting control information to decide a decoding start point of the image data from a header attached to the image data; storing the image data in each storage area assigned per the coding unit; waiting till the decoding start point of the image data decided based on the detected control information; instructing a start of decoding per the coding unit; and decoding the stored image data per the coding unit after the instruction to start decoding being received.

According to another embodiment of the present invention, there is provided a program causing a computer that controls a receiving apparatus to function as the receiving apparatus, wherein the receiving apparatus includes a header detection section that receives image data encoded per a coding unit corresponding to N (N is equal to or greater than 1) lines in one field and detects control information to decide a decoding start point of the image data from a header attached to the image data, a storage section that stores the image data in each storage area assigned per the coding unit, a decoding start instruction section that decides a decoding start point of the image data based on the control information detected by the header detection section and, after waiting till the decoding start point, instructs a start of decoding per the coding unit, and a decoding section that decodes the image data stored in the storage section per the coding unit after the instruction to start decoding being received from the decoding start instruction section.

According to another embodiment of the present invention, there is provided a communication system including a transmitting apparatus including a compression section that encodes image data per a coding unit corresponding to N (N is equal to or greater than 1) lines in one field and a communication section that transmits the image data encoded per the coding unit, and a receiving apparatus including a communication section that receives the image data encoded per the coding unit and transmitted from the transmitting apparatus, a header detection section that detects control information to decide a decoding start point of the image data from a header attached to the image data received by the communication section, a storage section that stores the image data in each storage area assigned per the coding unit, a decoding start instruction section that decides a decoding start point of the image data based on the control information detected by the header detection section and, after waiting till the decoding start point, instructs a start of decoding per the coding unit, and a decoding section that decodes the image data stored in the storage section per the coding unit after the instruction to start decoding being received from the decoding start instruction section.

According to a receiving apparatus, a receiving method, a program, and a communication system according to the present invention, as described above, synchronization can steadily be acquired in communication using a line-based codec.

### BRIEF DESCRIPTION OF THE DRAWINGS

FIG. 1 is a block diagram showing a configuration of a communication apparatus according to a first embodiment;

FIG. 2 is a block diagram showing a detailed configuration of a reception memory section according to the first embodiment;

FIG. 3 is an explanatory view showing the format of an IP packet as an example of communication data;

FIG. 4 is a flow chart showing the flow of determination processing at a time of starting decoding according to the first embodiment;

FIG. 5 is a flow chart showing the flow of decoding instruction processing according to the first embodiment;

FIG. 6 is a block diagram showing the configuration of a communication apparatus according to a second embodiment;

FIG. 7 is a block diagram showing the detailed configuration of a received data separation section and a reception memory section according to the second embodiment;

FIG. 8 is a flow chart showing the flow of transmission processing according to the second embodiment;

FIG. 9 is a flow chart showing the flow of reception processing according to the second embodiment;

FIG. 10 is a schematic diagram conceptually depicting a communication system according to a third embodiment;

FIG. 11 is a block diagram showing the configuration of a transmitting apparatus according to the third embodiment;

FIG. 12 is a block diagram showing the configuration of a receiving apparatus according to the third embodiment;

FIG. 13 is a flow chart showing the flow of transmission processing according to the third embodiment;

FIG. 14 is a flow chart showing the flow of reception processing according to the third embodiment;

FIG. 15 is a block diagram showing a configuration example of an encoder that performs wavelet conversion;

FIG. 16 is an explanatory view exemplifying band components obtained by splitting a band in a two-dimensional image;

FIG. 17 is a schematic diagram conceptually showing conversion processing by line-based wavelet conversion; and

FIG. 18 is a block diagram showing a configuration example of a general-purpose computer.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially similar function or structure are denoted with the same reference numerals, and duplicate explanation of these structural elements is omitted.

First, a mechanism of line-based wavelet conversion will be described as an example of the line-based codec.

Line-based wavelet conversion is a codec technology that performs wavelet conversion in the horizontal direction each time that one line of a baseband signal of an original image is scanned and performs wavelet conversion in the vertical direction each time a predetermined number of lines are read.

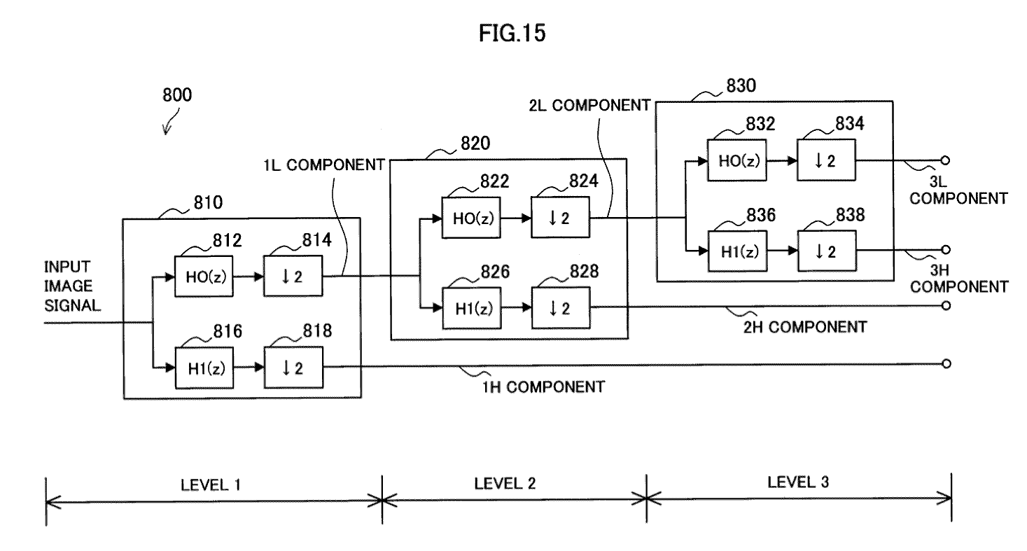

FIG. 15 is a block diagram showing a configuration example of an encoder 800 that performs wavelet conversion. The encoder 800 shown in FIG. 15 performs octave splitting, which is the most common wavelet conversion, in three layers (three levels) to generate hierarchically encoded image data.

Referring to FIG. 15, the encoder 800 includes a circuit section 810 at Level 1, a circuit section 820 at Level 2, and a circuit section 830 at Level 3. The circuit section 810 at Level 1 has a low-pass filter 812, a down sampler 814, a high-pass filter 816, and a down sampler 818. The circuit section 820 at Level 2 has a low-pass filter 822, a down sampler 824, a high-pass filter 826, and a down sampler 828. The circuit section 830 at Level 3 has a low-pass filter 832, a down sampler 834, a high-pass filter 836, and a down sampler 838.

An input image signal is split into bands by the low-pass filter 812 (transfer function H0 (z)) and the high-pass filter 816 (transfer function H1 (z)) of the circuit section 810. Low-frequency components (1L components) and high-frequency components (1H components) obtained by bandsplitting are thinned out to half in resolution by the down sampler 814 and the down sampler 818 respectively.

A signal of the low-frequency components (1L components) thinned out by the down sampler 814 is further split into bands by the low-pass filter 822 (transfer function H0 (z)) and the high-pass filter 826 (transfer function H1 (z)) of the circuit section 820. Low-frequency components (2L components) and high-frequency components (2H components) obtained by bandsplitting are thinned out to half in resolution by the down sampler 824 and the down sampler 828 respectively.

Further, a signal of the low-frequency components (2L components) thinned out by the down sampler 824 is further split into bands by the low-pass filter 832 (transfer function H0 (z)) and the high-pass filter 836 (transfer function H1 (z)) of the circuit section 820. Low-frequency components (3L components) and high-frequency components (3H components) obtained by bandsplitting are thinned out to half in resolution by the down sampler 834 and the down sampler 838 respectively.

Band components obtained by hierarchically splitting low-frequency components into bands up to a predetermined level are sequentially generated. In the example in FIG. 15, as a result of bandsplitting up to Level 3, high-frequency components (1H components) thinned out by the down sampler 818, high-frequency components (2H components) thinned out by the down sampler 828, high-frequency components (3H components) thinned out by the down sampler 838, and low-frequency components (3L components) thinned out by the down sampler 834 are generated.

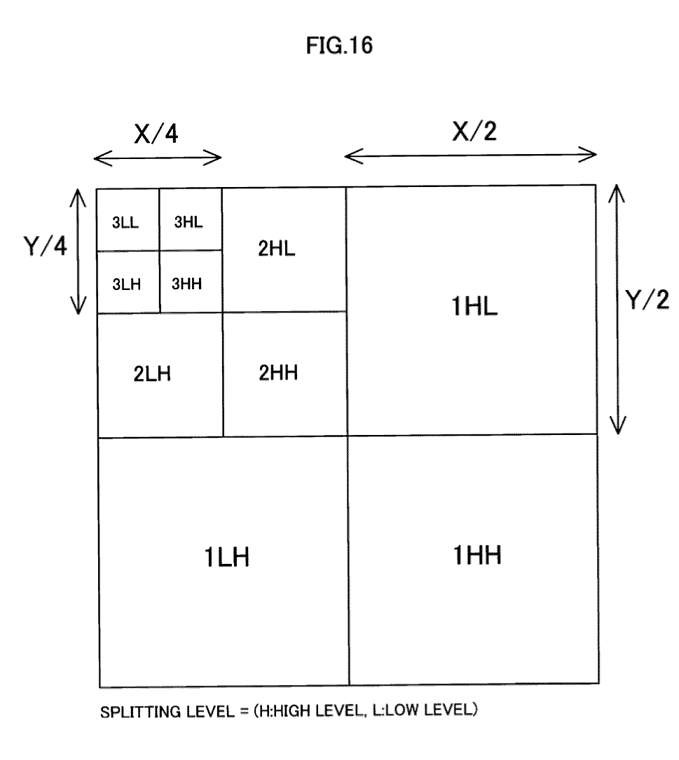

FIG. 16 is a diagram showing band components obtained as a result of splitting a two-dimensional image up to Level 3. In the example in FIG. 16, each sub-image of four components 1LL, 1LH, 1HL, and 1HH by bandsplitting (horizontal/vertical direction) at Level 1. Here, LL indicates that both horizontal and vertical components are L, and LH indicates that the horizontal component is H and the vertical component is L. Next, the 1LL component is again split into bands to acquire each sub-image of 2LL, 2HL, 2LH, and 2HH. Further, the 2LL component is again split into bands to acquire each sub-image of 3LL, 3HL, 3LH, and 3HH.

As a result of repeatedly performing wavelet conversion in this manner, output signals form a hierarchical structure of sub-images. Line-based wavelet conversion is obtained by further extending such wavelet conversion based on lines.

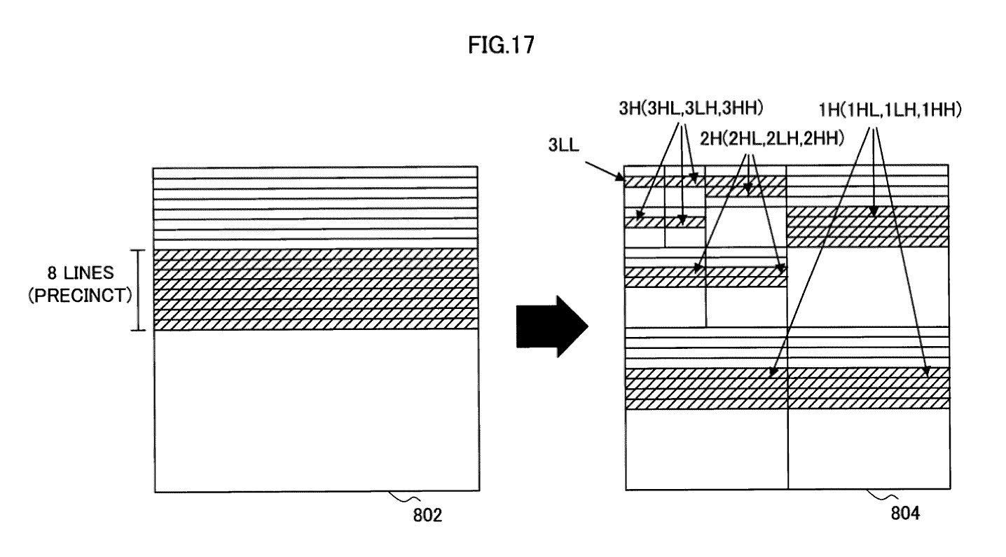

FIG. 17 is a schematic diagram conceptually showing conversion processing by line-based wavelet conversion. Here, as an example, wavelet conversion is performed in the vertical direction for each eight lines of baseband.

If, in this case, wavelet conversion is to be performed in three layers, with respect to the eight lines, one line of encoded data is generated for the lowest-level band 3LL sub-image and one line for each of sub-bands 3H (sub-images 3HL, 3LH, and 3HH) at the next level. Further, two lines are generated for each of sub-bands 2H (sub-images 2HL, 2LH, and 2HH) at the next level and further, four lines for each of the highest-level bands 1H (sub-images 1HL, 1LH, and 1HH).

A set of lines of each sub-band will be called a precinct. That is, the precinct is a set of lines to be the coding unit of line-based wavelet conversion as a form of a line block, which is a set of lines. Here, the coding unit has a general meaning, that is a set of lines to be the unit of coding processing and is not limited to the above line-based wavelet conversion. That is, the coding unit may be, for example, the unit of coding processing in existing hierarchical coding such as JPEG2000 and MPEG4, too.

Referring to FIG. 17, the precinct (shadow area in FIG. 17) consisting of eight lines in a baseband signal 802 shown on the left side in FIG. 17 is constituted, as shown on the right side in FIG. 17, as four lines (shadow area in FIG. 17) of each of 1HL, 1LH, and 1HH in 1H, two lines (shadow area in FIG. 17) of each of 2HL, 2LH, and 2HH in 2H, and one line (shadow area in FIG. 17) of each of 3LL, 3HL, 3LH, and 3HH in a line-based wavelet converted signal 804 after conversion.

According to such line-based wavelet conversion processing, processing can be performed by decomposing a picture into finer grain sizes, like tile decomposing in JPEG2000, so that a delay when image data is transmitted and received can be made shorter. Further, in contrast to tile decomposing in JPEG2000, line-based wavelet conversion carries out a division using a wavelet coefficient instead of a division for line-based signal and thus has a feature that no image quality deterioration like block noise occurs in tile boundaries.

Line-based wavelet conversion has been described above as an example of the line-based codec. Each embodiment of the present invention described below is not limited to line-based wavelet conversion and is applicable to any line-based codec such as the existing hierarchical coding, for example, JPEG2000 and MPEG4.

The first to third embodiments of the present invention to steadily acquire synchronization in communication using a line-based codec will be described below.

### [1] First Embodiment

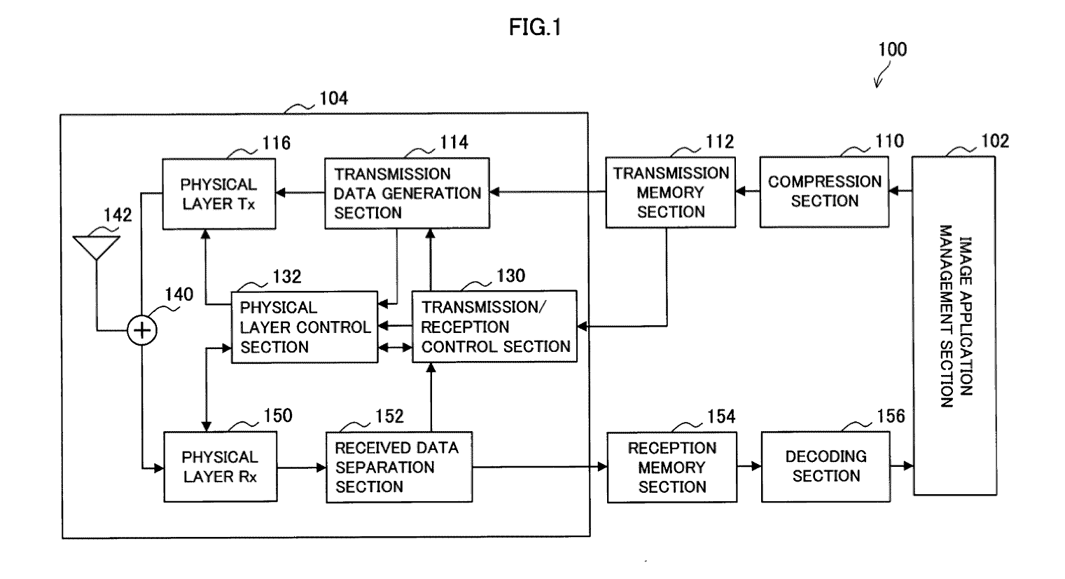

FIG. 1 is a block diagram showing the configuration of a communication apparatus 100 according to the first embodiment. Referring to FIG. 1, the communication apparatus 100 includes an image application management section 102, a compression section 110, a transmission memory section 112, a communication section 104, a reception memory section 154, and a decoding section 156. Further, the communication section 104 includes a transmission data generation section 114, a physical layer Tx 116, a transmission/reception control section 130, a physical layer control section 132, a switch section 140, an antenna section 142, a physical layer Rx 150, and a received data separation section 152.

The image application management section 102 accepts a transmission request of taken image data and executes path control and control of wireless lines based on QoS or manages input/output of image data with applications. Further, processing by the image application management section 102 may include control of an image input device such as a CCD (Charge Coupled Device) or CMOS (Complementary Metal Oxide Semiconductor) sensor.

The compression section 110 reduces the amount of data by coding image data supplied from the image application management section 102 per the coding unit of N lines (N is equal to or greater than 1) in one field according to the above line-based codec before outputting the image data to the transmission memory section 112.

The transmission memory section 112 temporarily stores data received from the compression section 110. The transmission memory section 112 may also have a routing function to manage routing information in accordance with the network environment and to control data transfer to other terminals. The transmission memory section 112 may also be combined with the reception memory section 154 described later to store not only transmission data, but also received data.

The transmission/reception control section 130 executes control of the MAC (Media Access Control) layer in the TDMA (Time Division Multiple Access) method or CSMA (Carrier Sense Multiple Access) method. The transmission/reception control section 130 may also execute control of the MAC layer based on PSMA (Preamble Sense Multiple Access) that identifies packets from a correlation of not the carrier, but the preamble.

The transmission data generation section 114 reads data stored in the transmission memory section 112 to generate a transmission packet based on a request from the transmission/reception control section 130. When, for example, communication based on the IP protocol is performed, the transmission data generation section 114 generates an IP packet containing encoded image data read from the transmission memory section 112.

The physical layer control section 132 controls the physical layer based on control from the transmission/reception control section 130 or the transmission data generation section 1 14. The physical layer Tx 116 starts an operation based on a request from the physical layer control section 132 and outputs communication packets supplied from the transmission data generation section 114 to the switch section 140.

The switch section 140 has a function to switch transmission and reception of data and, when communication packets are supplied from the physical layer Tx 116, transmits the communication packets via the antenna section 142. When communication packets are received via the antenna section 142, the switch section 140 supplies the received packets to the physical layer Rx 150.

The physical layer Rx 150 starts an operation based on a request from the physical layer control section 132 and supplies received packets to the received data separation section 152.

The received data separation section 152 analyzes received packets supplied from the physical layer Rx 150 and separates image data and control data to be delivered to the image application management section 102 to output the image data and control data to the reception memory section 154. When, for example, communication based on the IP protocol is performed, the received data separation section 152 references the destination IP address and destination port number contained in a received packet so that image data and the like can be output to the reception memory section 154. The received data separation section 152 may also have a routing function to control data transfer to other terminals.

The reception memory section 154 temporarily stores data output from the received data separation section 152 and outputs data to be decoded to the decoding section 156 after determining the time at which decoding should start. A detailed configuration of the reception memory section 154 will be described later in more detail.

The decoding section 156 decodes data output from the reception memory section 154 per unit of N lines (N is equal to or greater than 1) in one field and then outputs the data to the image application management section 102.

The configuration of the communication apparatus 100 according to the present embodiment has been described above using FIG. 1. Note that in a transmission/reception system based on a pictured-based codec, an algorithm of frame prediction, field prediction and the like is generally implemented in the decoding section, instead of implementing strict synchronization control. The frame prediction is to realize high compression efficiency of image data by coding, for example, only differential data between frames. However, if such an algorithm is implemented with a line-based codec, an advantage of shorter delay is diminished. Thus, in the configuration of the communication apparatus 100 according to the present embodiment, synchronization when image data is received is strictly controlled by processing described below when decoding is started.

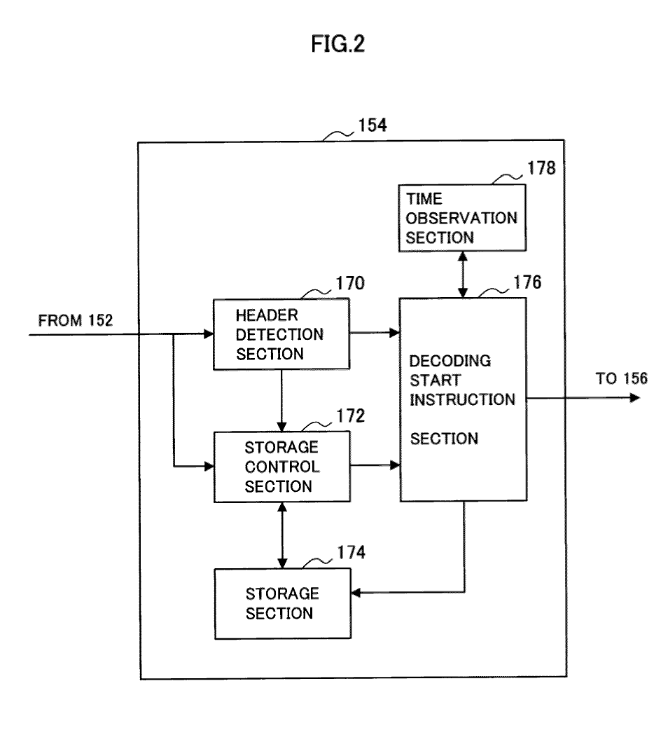

FIG. 2 is a block diagram showing a detailed configuration of the reception memory section 154. Referring to FIG. 2, the reception memory section 154 includes a header detection section 170, a storage control section 172, a storage section 174, a decoding start instruction section 176, and a time observation section 178.

The header detection section 170 receives image data encoded per the coding unit corresponding to N lines (N is equal to or greater than 1) in one field from the received data separation section 152 and detects the header of the received image data. Then, the header detection section 170 recognizes to which line (or line block) of which picture each piece of data corresponds using the detected header and outputs the recognized information as control information to the storage control section 172 and the decoding start instruction section 176. Such information is used, for example, by the decoding start instruction section 176 described later to determine the time point at which decoding of image data is started.

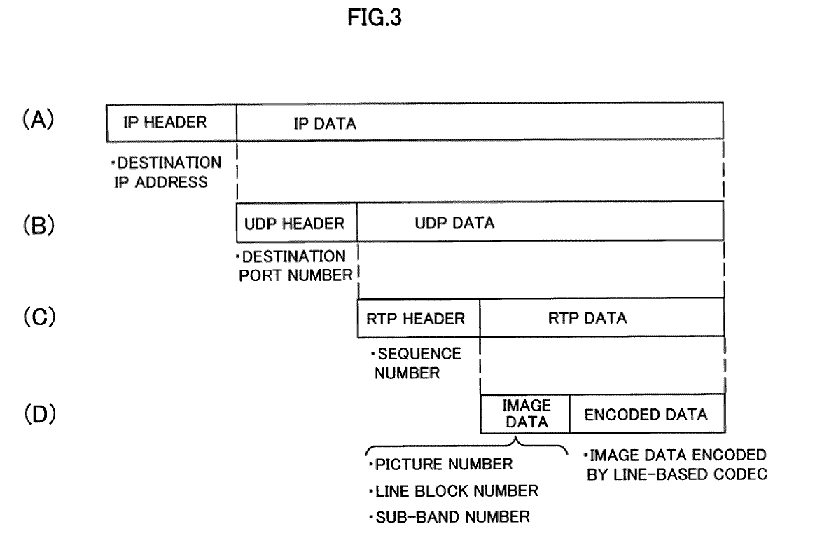

FIG. 3 shows the format of an IP packet as an example of communication data that may be received by the communication apparatus 100 according to the present embodiment.

In FIG. 3, the internal configuration of one IP packet is shown in four stages of FIGS. 3(A) to (D). Referring to FIG. 3(A), an IP packet is constituted by an IP header and IP data. The IP header contains, for example, control information on control of communication paths based on the IP protocol such as a destination IP address.

IP data is further constituted by a UDP header and UDP data (FIG. 3(B)). The UDP is a protocol in the transport layer of the OSI reference model used generally for delivery of moving images or sound data in which real-time properties are important. The UDP header contains, for example, the destination port number, which is application identification information.

UDP data is further constituted by an RTP header and RTP data (FIG. 3(C)). The RTP header contains, for example, control information to guarantee real-time properties of a data stream such as the sequence number.

In the present embodiment, RTP data is constituted by a header (hereinafter, referred to as an image header) of image data and encoded data, which is an main body of an image compressed based on the line-based codec (FIG. 3(D)). The image header may contain, for example, the picture number, line block number (or line number when encoded per unit of one line), or sub-band number. The image header may further be constituted by a picture header attached to each picture and a line block header attached to each line block.

The header detection section 170 shown in FIG. 2 detects such an image header and extracts control information contained in the image header. For example, the header detection section 170 can recognize the head position from the picture number. Similarly, the header detection section 170 can recognize to which line block in a picture each piece of data corresponds from the line block number.

The storage control section 172 controls storage of image data in the storage section 174 depending on the position of each piece of image data output from the header detection section 170 in an image (that is, the corresponding line (or line block) in a picture).

The storage section 174 temporarily stores received image data under control of the storage control section 172. In the storage section 174, image data is typically stored in predetermined storage areas assigned corresponding to positions in an image recognized by the header detection section 170.

The decoding start instruction section 176 determines the time point at which decoding of image data is started based on control information output from the header detection section 170 indicating that the head of a picture has been recognized. Then, after waiting till the time to start decoding, the decoding start instruction section 176 instructs the decoding section 156 to read image data per the coding unit (that is, in units of line or line block) from the storage section 174 and to start decoding. The decoding start instruction section 176 is caused to wait until the decoding start point by causing the time observation section 178 to observe the time.

Here, in the present embodiment, the time when a fixed time passes after the time when the head of a picture is recognized is defined as the decoding start point. For example, a time capable of absorbing fluctuations in data amount in each coding unit and a delay caused by an influence of jitters in communication paths and the like is suitably retained in the above fixed time.

The time observation section 178 measures the time to wait till the decoding start point under control of the decoding start instruction section 176. The time observation section 178 can typically be implemented as a timer.

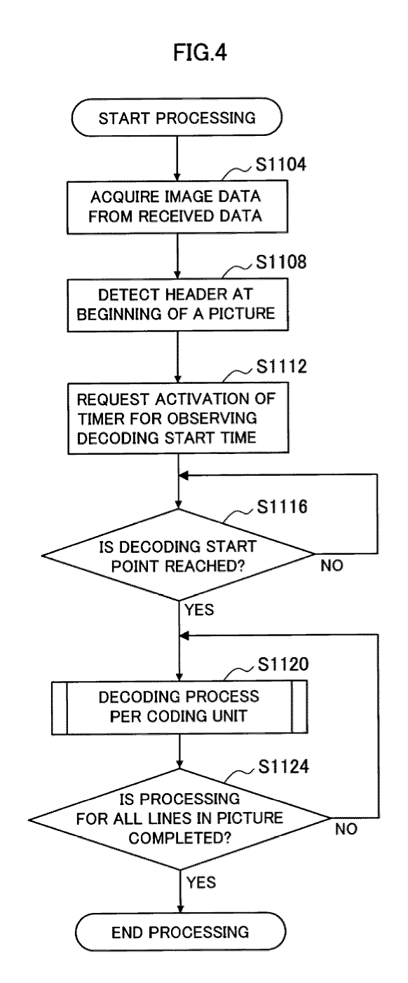

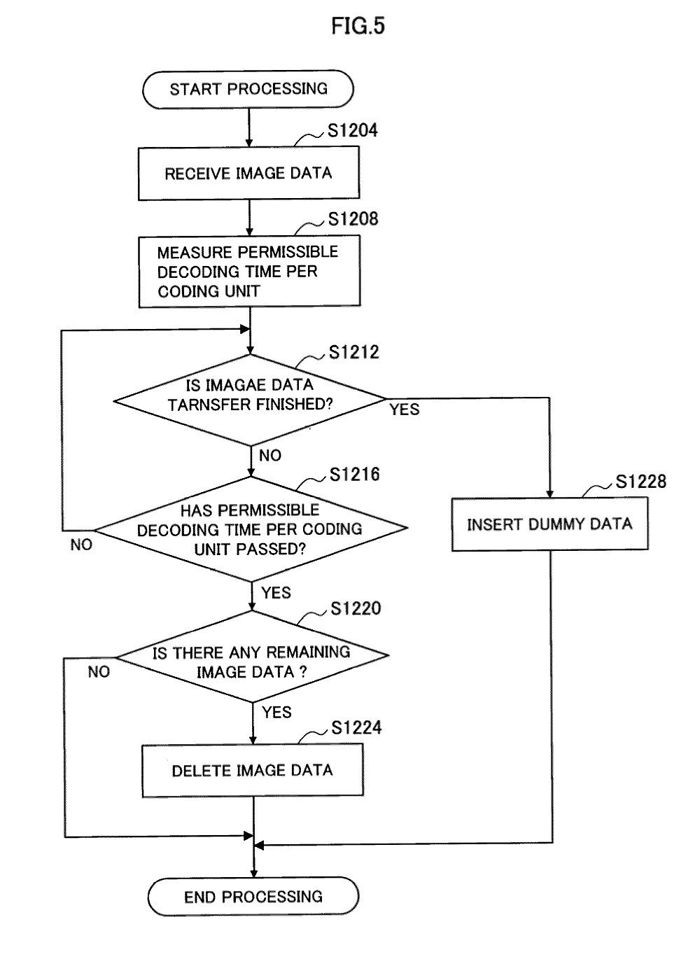

Next, the flow of synchronization processing in the communication apparatus 100 configured as described above will be described with reference to FIG. 4 and FIG. 5.

Synchronization processing of image data in the communication apparatus 100 is divided into determination processing of the decoding start point for each picture and decoding instruction processing per the coding unit (in units of line or block line). FIG. 4 is a flow chart showing, of the above processing, the flow of determination processing of the decoding start point for each picture.

Referring to FIG. 4, from communication data received by the communication section 104, image data encoded per the predetermined coding unit is first separated and acquired by the received data separation section 152 (S1104).

Subsequently, the header detection section 170 detects the header from the image data acquired by the received data separation section 152. When the head of a picture is recognized, the header detection section 170 outputs control information to notify the decoding start instruction section 176 that the head of a picture has been recognized (S1108). The header detection section 170 further recognizes to which line (or line block) of which picture each piece of data corresponds and causes the storage section 174 to store image data via the storage control section 172.

After receiving control information indicating that the head of a picture has been recognized, the decoding start instruction section 176 requests the time observation section 178 to start time observation and waits until the decoding start point is reached (S1112).

Subsequently, when it is determined that the decoding start point is reached (S1116), processing switches to decoding processing in the coding unit (S1120). Decoding processing in the coding unit will be described in detail using FIG. 5. Decoding processing in the coding unit will be repeated until processing for all lines in a picture is completed (S1124). Then, when processing for all lines is completed, the present flow chart ends.

FIG. 5 is a flow chart showing the flow of decoding instruction processing per the coding unit in the first embodiment, that is, in units of line or block line.

Referring to FIG. 5, the decoding start instruction section 176, which has determined the decoding start point, first instructs the decoding section 156 to start decoding so that image data to be decoded is transferred from the storage section 174 to the decoding section 156 (S1204).

Then, along with the transfer of image data, a permissible decoding time per the coding unit is measured by the decoding start instruction section 176 (S1208). Here, the permissible decoding time per the coding unit means a duration that can be expended to display image data involved in one coding unit. When, for example, video of 1080/60 p (progressive system of 60 fps in a screen size of 2200×1125) is to be decoded, the duration that can be expended for displaying one line is about 14.8 [μs] if the blank time is considered and about 15.4 [μs] if the blank time is not considered. Then, if the coding unit is a line block of N lines, the permissible decoding time per the coding unit will be N times the duration that can be expended for the display of one line.

Subsequently, whether the transfer of image data from the storage section 174 to the decoding section 156 completes before the processing time per the coding unit passes is monitored (S1212). Here, if the transfer of image data completes before the processing time per the coding unit passes, that is, less image data than assumed is received, processing proceeds to S1228.

At S1228, a case in which reception of image data to be decoded has not been completed due to a delay in communication or the like can be considered. At this point, since displaying image is delayed due to the shifts of the synchronization timing by waiting a reception completion of image data to be decoded, the decoding start instruction section 176 inserts dummy data into the corresponding line (or the corresponding line block) without waiting for a completion of reception of the image data. For example, image data of the same line in the previous picture (or a picture prior to the previous picture) can be used as the dummy data inserted here. However, the dummy data is not limited to such an example and may be any data such as fixed image data or data predicted by motion complementation technique.

If, on the other hand, the permissible decoding time per the coding unit passes before the transfer of image data completes (S1216), whether at this point image data to be decoded remains in the storage section 174 is determined (S1220). If no image data remains, decoding processing per the coding unit completes. If, on the other hand, image data remains at S1220, the remaining image data is deleted (S1224) and decoding processing in the coding unit completes.

When the processing time per one coding unit passes at S1216, a decoding instruction for the next coding unit is suitably provided while continuously operating a counter for time measurement without a pause or reset. Accordingly, for example, decoding processing is performed without fluctuations in decoding timing per the coding unit of line block.

Instead, a time control section (not shown) may be provided in the communication apparatus 100 separately from the counter for time measurement so that, for example, at S1208, the time control section is caused to notify the reception memory section 154 or the decoding section 156 of the timing of start/end of processing for each coding unit.

The first embodiment of the present invention has been described above using FIG. 1 to FIG. 5. In the present embodiment, the header detection section 170 outputs control information indicating that the head of a picture has been recognized and the decoding start instruction section 176 determines the time point when a predetermined time passes after the control information being output as the decoding start point. Then, after waiting till the decoding start point, the decoding start instruction section 176 sequentially measures the permissible decoding time for each coding unit and instructs the decoding section 156 to start decoding in the coding unit each time the permissible decoding time passes.

According to the configuration described above, image data can steadily be decoded in the coding unit in synchronization even in a line-based codec in which the time that can be used for control of reception and decoding of image data is shorter than in a picture-based codec.

If reception of image data to be decoded in the coding unit is not complete, the decoding start instruction section 176 inserts dummy data instead of image data of which reception has not been completed. Accordingly, an occurrence of shifts of the synchronization timing due to a reception delay of image data to be decoded can be prevented.

At this point, image data in the same line or line block of the previous picture or a picture prior to the previous picture as that of the image data to be decoded may be used. Accordingly, an image containing dummy data can be displayed without causing a user to perceive picture quality deterioration due to insertion of dummy data.

If image data to be decoded still remains when the permissible decoding time per the coding unit passes, the decoding start instruction section 176 makes the image data to be decoded to be deleted. Accordingly, decoding can be performed steadily in synchronization without decoding of subsequent lines or line blocks being affected even if decoding of a specific line or line block is not completed due to a temporary increase in data amount.

In the present embodiment, the communication apparatus 100 is described as a wireless communication terminal, but the communication apparatus 100 is not limited to the wireless communication terminal. The communication apparatus 100 may be a communication apparatus or information processing apparatus using any kind of wired communication or wireless communication.

While the storage section 174 is described as predetermined storage areas assigned corresponding to each position in an image, the storage areas do not have to be fixed for each position in an image. By providing header information with storage areas, it is allowed to determine the image position in a shared storage area.

While, in the present embodiment, the timing to start decoding is determined by recognizing the head of a picture, the timing to start decoding may be determined from a midpoint position of a picture instead of the head by preparing information allowing to identify the coding unit of which data is currently being processed. For example, the coding unit of which data is currently being processed can be identified by the line block number shown in FIG. 3.

IP, UDP, and RTP have been described as data formats to be transmitted/received, but the formats that can be handled in the present embodiment are not limited to the above examples. For example, TCP may be used in place of UDP. Further, the formats may be replaced by an individually defined format or any part of format may be deleted for transmission/reception.

### [2] Second Embodiment

In the first embodiment, decoding for each line (for each line block) in a picture starts when a predetermined time passes after the head of a picture is recognized in the communication apparatus 100.

Here, while generally the data rate in communication between transmitting and receiving apparatuses is temporarily fixed, the amount of data involved in each coding unit obtained as a result of coding processing depends on the coding mode and changes depending on content of data. Transmission waiting may also occur on the transmitting side due to changes of a communication environment between transmitting and receiving apparatuses. Thus, the waiting time until transmission/reception processing starts after completion of coding processing for each piece of image data may fluctuate.

Thus, in the second embodiment described below, the decoding start point is further adjusted in accordance with delay conditions on the transmitting side of data.

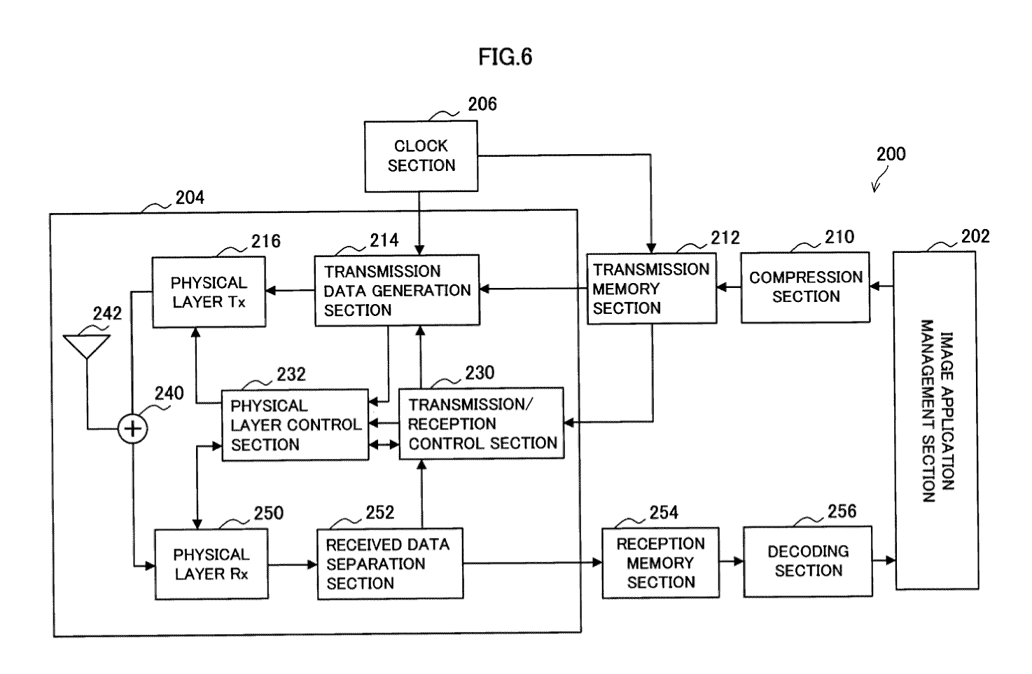

FIG. 6 is a block diagram showing the configuration of a communication apparatus 200 according to the second embodiment. Referring to FIG. 6, the communication apparatus 200 includes an image application management section 202, a compression section 210, a transmission memory section 212, a communication section 204, a clock section 206, a reception memory section 254, and a decoding section 256. Further, the communication section 204 includes a transmission data generation section 214, a physical layer Tx 216, a transmission/reception control section 230, a physical layer control section 232, a switch section 240, an antenna section 242, a physical layer Rx 250, and a received data separation section 252.

The image application management section 202, the compression section 210, and the decoding section 256 have functions similar to those of the image application management section 102, the compression section 110, and the decoding section 156 of the communication apparatus 100 according to the first embodiment described using FIG. 1 respectively.

The clock section 206 is typically implemented as a timer which holds time information in the communication apparatus 200 and outputs time information, for example, in accordance with a request from the transmission memory section 212 or the transmission data generation section 214.

In addition to the function of the transmission memory section 112 according to the first embodiment, the transmission memory section 212 inserts time information as a time stamp acquired from the clock section 206 into the header of image data encoded by the compression section 210 using a line-based codec. The time stamp inserted here is a time stamp corresponding to the time that encoding of image data is completed and is defined as an image time stamp. For example, an image time stamp may be inserted into the image header in FIG. 3(D).

In addition to the function of the transmission data generation section 114 according to the first embodiment, the transmission data generation section 214 inserts time information acquired from the clock section 206 as a time stamp into the header of communication data before the generated communication data being output to the physical layer Tx. The time stamp inserted here is a time stamp corresponding to the time that communication data is output and is defined as a transmission time stamp. For example, a transmission time stamp may be inserted into the RTP header in FIG. 3(C).

The physical layer Tx 216, the transmission/reception control section 230, the physical layer control section 232, the switch section 240, the antenna section 242, and the physical layer Rx 250 have functions similar to those of the physical layer Tx 116, the transmission/reception control section 130, the physical layer control section 132, the switch section 140, the antenna section 142, and the physical layer Rx 150 of the communication apparatus 100 described using FIG. 1 respectively.

In addition to the function of the received data separation section 152 according to the first embodiment, the received data separation section 252 acquires a transmission time stamp by detecting the header (hereinafter, referred to as the communication header) of received communication data and outputs the transmission time stamp to the reception memory section 254.

In addition to the function of the reception memory section 154 according to the first embodiment, the reception memory section 254 acquires an image time stamp by detecting the header of received image data. Then, the reception memory section 254 calculates a difference between the transmission time stamp output from the received data separation section 252 and the image time stamp to adjust the decoding start point of image data.

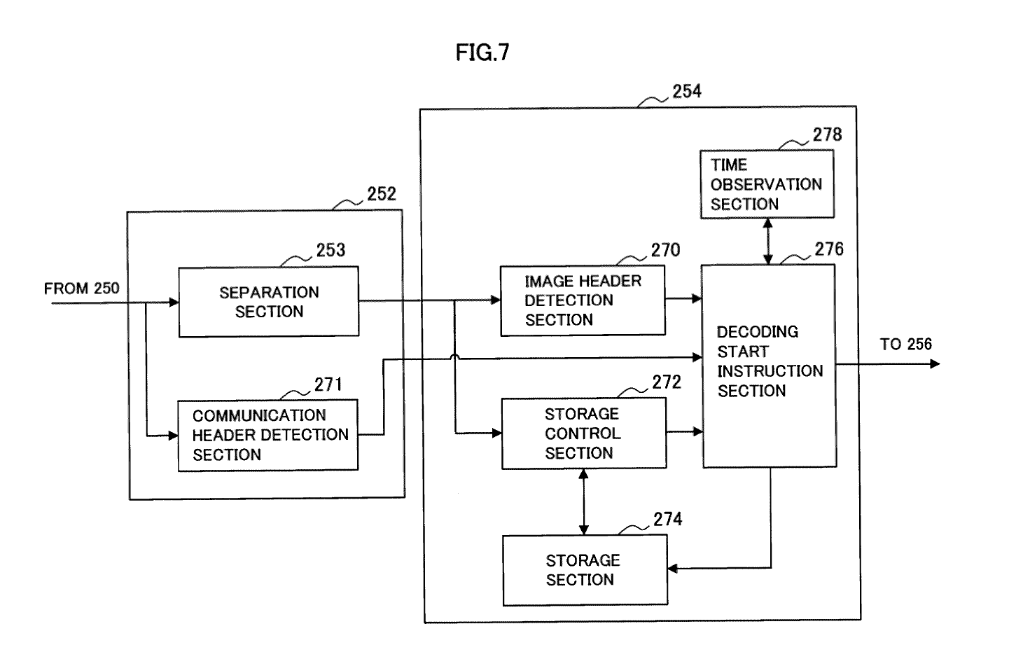

FIG. 7 is a block diagram showing the detailed configuration of the received data separation section 252 and the reception memory section 254 according to the second embodiment. Referring to FIG. 7, the received data separation section 252 has a separation section 253 and a communication header detection section 271. The reception memory section 254 includes an image header detection section 270, a storage control section 272, a storage section 274, a decoding start instruction section 276, and a time observation section 278.

The separation section 253 analyzes received packets supplied from the physical layer Rx 250 as communication data to separate image data and control data necessary for the image application management section 202 and outputs the image data and control data to the reception memory section 254.

The communication header detection section 271 detects a transmission time stamp inserted by the transmission data generation section 214 of a transmission source apparatus from the communication header contained in received data and outputs the transmission time stamp to the decoding start instruction section 276. While a transmitting apparatus and a receiving apparatus are different apparatuses in actual transmission/reception of data, for convenience of description, reference numerals of each block shown in FIG. 6 and FIG. 7 are used in both the processing block relating to transmission processing and that relating to reception processing are attached for description.

In addition to the function of the image header detection section 170 according to the first embodiment, the image header detection section 270 detects an image time stamp inserted into the header of image data by the transmission memory section 212 of a transmitting apparatus and outputs the image time stamp to the decoding start instruction section 276.

The storage control section 272 and the storage section 274 have functions similar to those of the storage control section 172 and the storage section 174 of the communication apparatus 100 described using FIG. 2.

The decoding start instruction section 276 calculates a time difference between a transmission time stamp output from the communication header detection section 271 and an image time stamp output from the image header detection section 270 and adjusts the waiting time till the decoding start point by using the calculated time difference. The transmission time stamp is, as described above, a time stamp corresponding to the time of image data transmission. The image time stamp is a time stamp corresponding to the time of image data encoding. A waiting time T till the decoding start point can be calculated using a transmission time stamp t₁ and an image time stamp t₂ as shown by the formula below.

### [Math 1]

T=T_{c}−(t₁−t₂) (1)

Here, T_{c} is, like in the first embodiment, a predetermined time. T_{c} is provided as a time capable of absorbing a delay due to an influence of fluctuations in data amount in each coding unit or jitters of communication paths, a hardware delay or memory delay.

After the decoding start instruction section 276 determines the waiting time T till the decoding start point in this manner, the decoding start instruction section 276 causes the time observation section 278 to check the time T to determine whether the decoding start point has come. Then, when the decoding start point comes, the decoding start instruction section 276 instructs the decoding section 256, as described in the first embodiment, to sequentially read and decode image data from the storage section 274 per the coding unit (in units of line or line block).

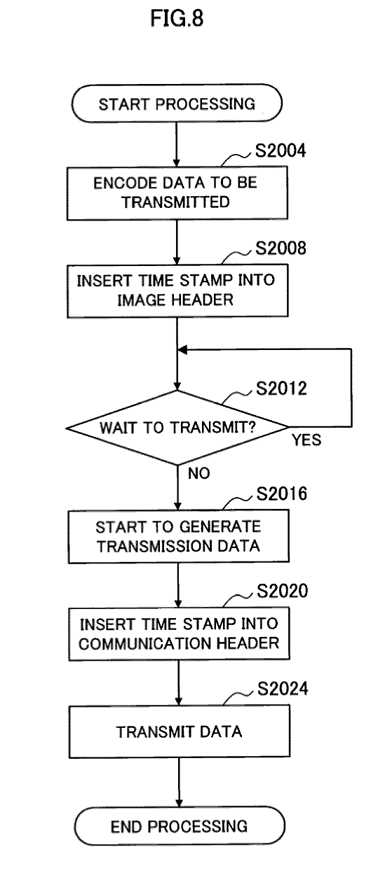

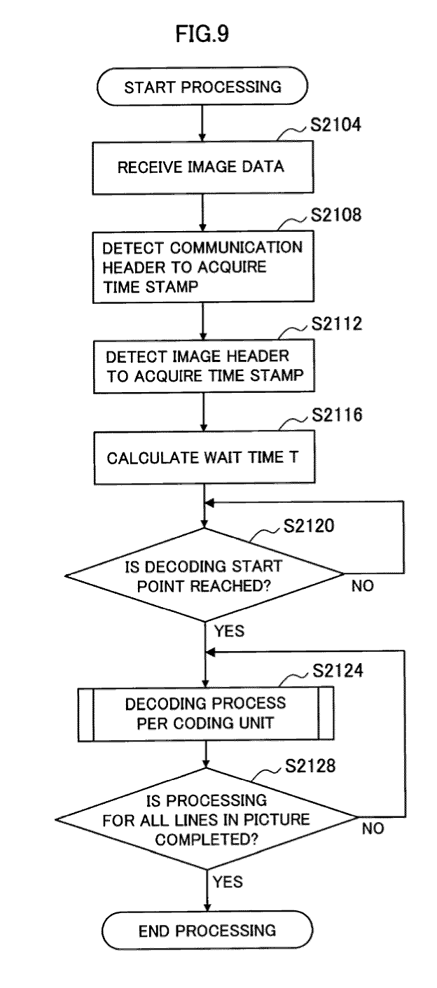

Next, the flow of transmission processing and reception processing of image data in the communication apparatus 200 configured in this manner will be described using FIG. 8 and FIG. 9.

FIG. 8 is a flow chart showing the flow of transmission processing of image data in the communication apparatus 200.

Referring to FIG. 8, image data is first encoded per the coding unit of N lines (N is equal to or greater than 1) in one field by the compression section 210 and output to the transmission memory section 212 (S2004).

Then, the transmission memory section 212 acquires time information from the clock section 206 and inserts the acquired time information into the header of encoded image data as an image time stamp (S2008). Subsequently, image data is stored in the transmission memory section 212 in accordance with the communication path and with the progress of transmission processing (S2012).

Then, when the transmission timing comes, image data is output from the transmission memory section 212 to the transmission data generation section 214 to start generating communication data including image data (S2016). At this point, the transmission data generation section 214 acquires time information from the clock section 206 and inserts the acquired time information into the header of communication data as a transmission time stamp (S2020). Subsequently, communication data is transmitted via the physical layer Tx 216 (S2024).

Next, FIG. 9 is a flow chart showing the flow of reception processing of image data in the communication apparatus 200.

Referring to FIG. 9, image data encoded per the coding unit described above is first separated and acquired by the separation section 253 from communication data received from the physical layer Rx 250 (S2104).

Further, the communication header of the received communication data is detected by the communication header detection section 271 and a transmission time stamp is acquired (S2108). The transmission time stamp acquired here is output to the decoding start instruction section 276.

Subsequently, the image header is detected by the image header detection section 270 from the image data output from the separation section 253 and an image time stamp is acquired (S2112). The image time stamp acquired here is output to the decoding start instruction section 276. At this point, the image header detection section 270 further recognizes to which line (or line block) of which picture each piece of data corresponds and outputs the recognized information to the storage control section 272 to cause the storage section 274 to store the recognized information.

After receiving a transmission time stamp and an image time stamp, the decoding start instruction section 276 calculates the waiting time T till the decoding start point according to the aforementioned formula (1) (S2116). Then, the decoding start instruction section 276 requests the time observation section 278 to start observation of the time up to the waiting time T and waits until the decoding start point is reached (S2120).

Subsequently, when it is determined that the decoding start point is reached (S2120), processing switches to decoding processing per the coding unit (S2124). The decoding processing per the coding unit here is processing similar to that according to the first embodiment described using FIG. 5.

Then, decoding processing in the coding unit will be repeated until processing for all lines in a picture is completed (S2128) and reception processing ends when processing for all lines is completed.

The second embodiment of the present invention has been described above using FIG. 6 to FIG. 9. In the present embodiment, a header detection section includes the communication header detection section 271 to detect a transmission time stamp corresponding to the time of data transmission from a communication header and the image header detection section 270 to detect an image time stamp corresponding to the time of coding from an image header. Then, the decoding start instruction section 276 adjusts the decoding start point in accordance with a time difference between the transmission time stamp and image time stamp output from these two header detection sections.

According to the configuration described above, decoding can be performed steadily in synchronization by absorbing fluctuations in reception timing of image data even if a waiting for data transmission occurs on the transmitting side due to changes in data amount in each coding unit and changes of a communication environment between transmitting and receiving apparatuses.

In the present embodiment, like the first embodiment, the communication apparatus 200 is not limited to a wireless communication apparatus. The communication apparatus 200 may be, for example, a communication apparatus or information processing apparatus mutually connected by any kind of wire communication or wireless communication.

While FIG. 7 shows an example in which the communication header detection section 271 is arranged in the received data separation section 252 and the image header detection section 270 in the reception memory section 254, but the configuration of the communication apparatus 200 is not limited to the above example. For example, the communication header detection section 271 may be arranged in the reception memory section 254.

If the rollup cycle of the transmission time stamp and that of the image time stamp are different, for example, processing to correct the bit width of a time stamp may be performed in the image header detection section 270 or the communication header detection section 271.

Additionally, a time difference between the transmission time stamp t₁ and the image time stamp t₂ may be calculated in advance on the transmitting side and the obtained time difference information may be inserted into the header. Accordingly, it becomes possible to reduce the data amount of the header area and also the workload of processing on the receiving side (decoding side).

### [3] Third Embodiment

In the first and second embodiments, decoding for each line (or line block) in a picture is started after the head of the picture being recognized in the communication apparatus 100 and the communication apparatus 200. That is, the decoding start point in lines (or line blocks) depends on when transmission processing on the transmitting side starts. If the transmitting and receiving apparatuses are configured one-to-one, no issue arises. However, when a plurality of transmitting apparatuses exists per one receiving apparatus, there may be a situation in which synchronization fails when a plurality of pieces of image data is managed or integrated on the receiving side. Thus, in the third embodiment of the present invention described below, image data is transmitted/received after the transmitting side further being notified of the transmission start time from the receiving side.

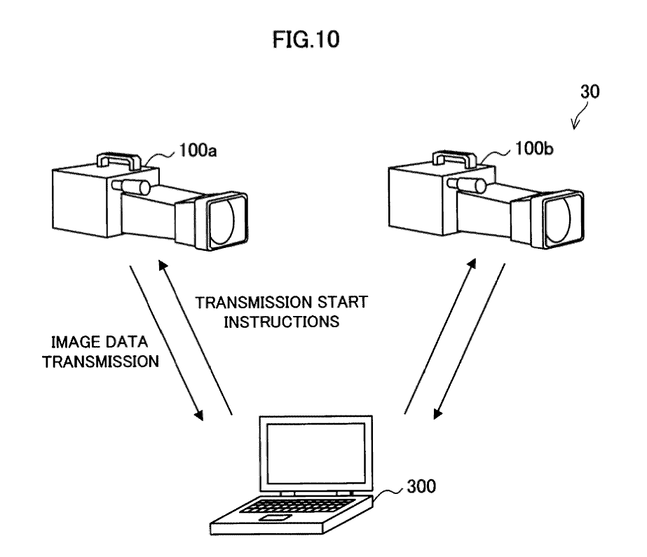

FIG. 10 is a schematic diagram conceptually depicting a communication system 30 according to the third embodiment of the present invention. Referring to FIG. 10, the communication system 30 includes transmitting apparatuses 100a and 100b and a receiving apparatus 300.

Each of the transmitting apparatuses 100a and 100b is an apparatus that shoots an object to generate a sequence of image data and transmits the image data to the receiving apparatus 300. While video cameras are shown in FIG. 10 as an example of the transmitting apparatuses 100a and 100b, the transmitting apparatuses 100a and 100b are not limited to video cameras. For example, the transmitting apparatuses 100a and 100b may be digital still cameras, PCs, mobile phones, or game machines having a function to shoot moving images.

The receiving apparatus 300 is an apparatus to play the role of a master to determine the transmission/reception timing of image data in the communication system 30. While a PC is shown in FIG. 10 as an example of the receiving apparatus 300, the receiving apparatus 300 is not limited to a PC. For example, the receiving apparatus 300 may be a video processing device for business or home use such as a video recorder, a communication apparatus, or any information processing apparatus.

In FIG. 10, the receiving apparatus 300 is connected to the transmitting apparatuses 100a and 100b by wireless communication based on standard specifications such as IEEE802.11a, b, g, n, and s. However, communication between the receiving apparatus 300 and the transmitting apparatuses 100a and 100b may be performed not by wireless communication, but by any kind of wire communication.

Hereinafter, transmission/reception of image data between the receiving apparatus 300 and the transmitting apparatus 100a will herein be described. Transmission/reception of image data between the receiving apparatus 300 and the transmitting apparatus 100b is also performed in the same manner as described below.

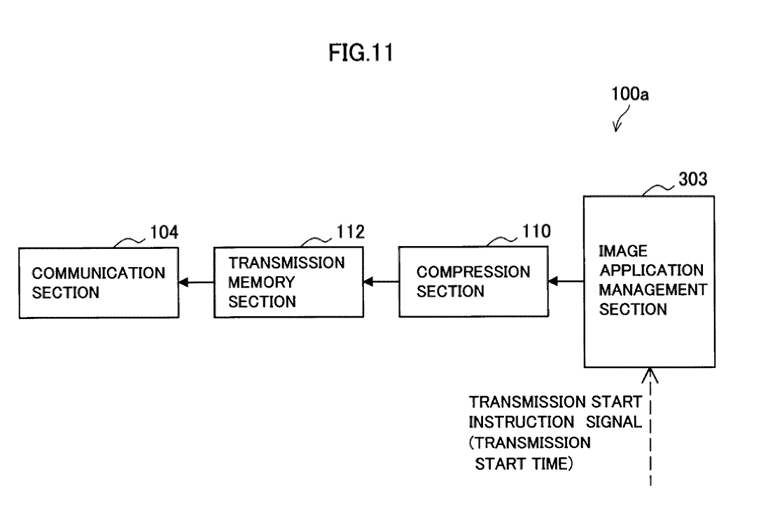

FIG. 11 is a block diagram showing the configuration of the transmitting apparatus 100a according to the third embodiment. Referring to FIG. 11, the transmitting apparatus 100a includes an image application management section 303, the compression section 110, the transmission memory section 112, and the communication section 104.

The image application management section 303 receives a transmission request for transmitting image data shot by the transmitting apparatus 100a from an application to execute the aforementioned path control and the like and also adjusts the transmission timing of image data to the receiving apparatus 300. More specifically, the image application management section 303 receives a transmission start instruction signal transmitted from a synchronization control section 390 of the receiving apparatus 300 described later and outputs image data to the compression section 110 at the specified transmission start time.

The compression section 110, the transmission memory section 112, and the communication section 104 perform transmission processing of a sequence of image data per the coding unit described in connection with the first embodiment on image data supplied from the image application management section 303 at the transmission start time.

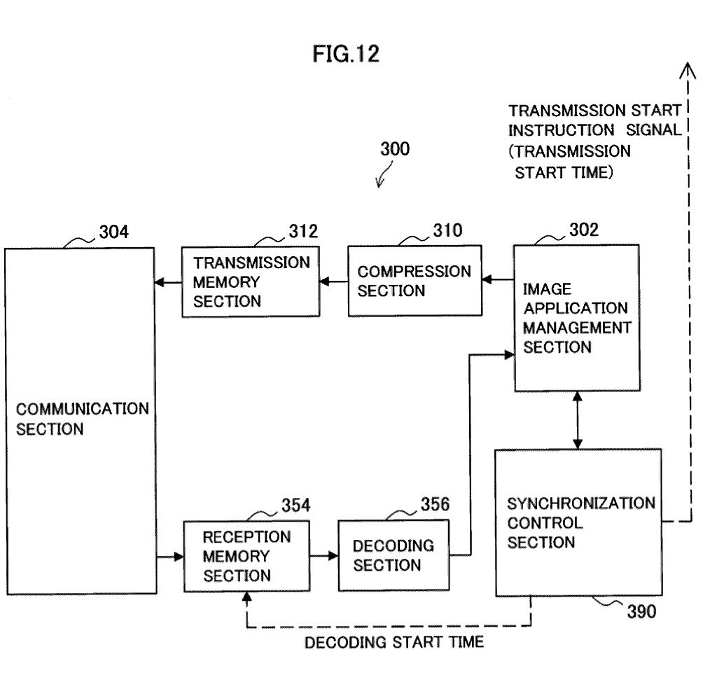

FIG. 12 is a block diagram showing the configuration of the receiving apparatus 300 according to the third embodiment. Referring to FIG. 12, the receiving apparatus 300 includes an image application management section 302, a compression section 310, a transmission memory section 312, a communication section 304, a reception memory section 354, a decoding section 356, and a synchronization control section 390.

Among these components, the image application management section 302, the compression section 310, the transmission memory section 312, the communication section 304, and the decoding section 356 have functions similar to those of the image application management section 102, the compression section 110, the transmission memory section 1 12, the communication section 104, and the decoding section 156 according to the first embodiment respectively.

The reception memory section 354 has a configuration similar to that of the reception memory section 154 described using FIG. 2 and, after received image data temporarily being stored, outputs the image data to the decoding section 356 at a predetermined decoding start point. In this regard, in contrast to the first embodiment, the decoding start instruction section 176 of the reception memory section 354 decides the decoding start time acquired from the synchronization control section 390 as the decoding start point of image data.

The synchronization control section 390 plays the role of a timing controller that controls the transmission/reception timing of image data between apparatuses in the communication system 30. Like the image application management section 302, the synchronization control section 390 is typically implemented as processing in the application layer.

Adjustments of the transmission/reception timing of image data by the synchronization control section 390 are started according to instructions from the image application management section 302 or triggered by reception of a synchronization request signal from the transmitting apparatus 100a or the like. Then, the synchronization control section 390 transmits a transmission start instruction signal designating the transmission start time of image data to the transmitting apparatus 100a and designates the decoding start time for the reception memory section 354.

At this point, the transmission start time transmitted to the transmitting apparatus 100a is a time obtained by subtracting a time interval necessary to absorb a delay caused by fluctuations in data amount in each coding unit or fluctuations of communication environment such as jitters of communication paths and a hardware delay or memory delay from the decoding start time designated for the reception memory section 354.

Though FIG. 11 and FIG. 12 show as if the transmission start instruction signal were exchanged directly between the image application management section 303 and the synchronization control section 390, for convenience of description, but the transmission start instruction signal is actually transmitted and received via the communication sections 104 and 304.

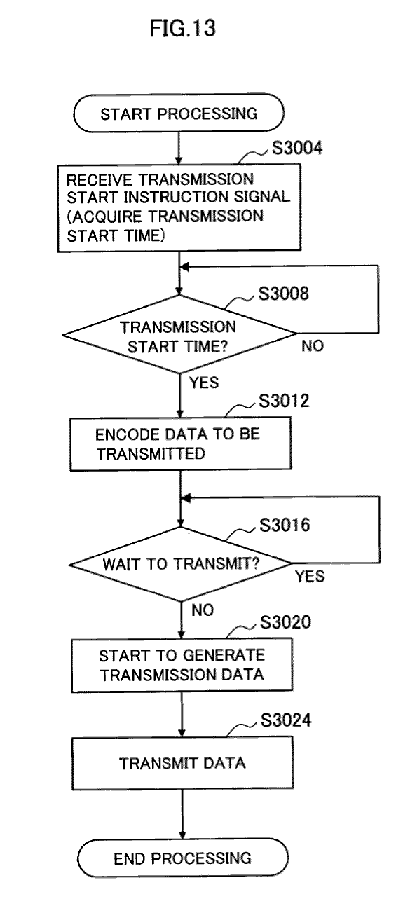

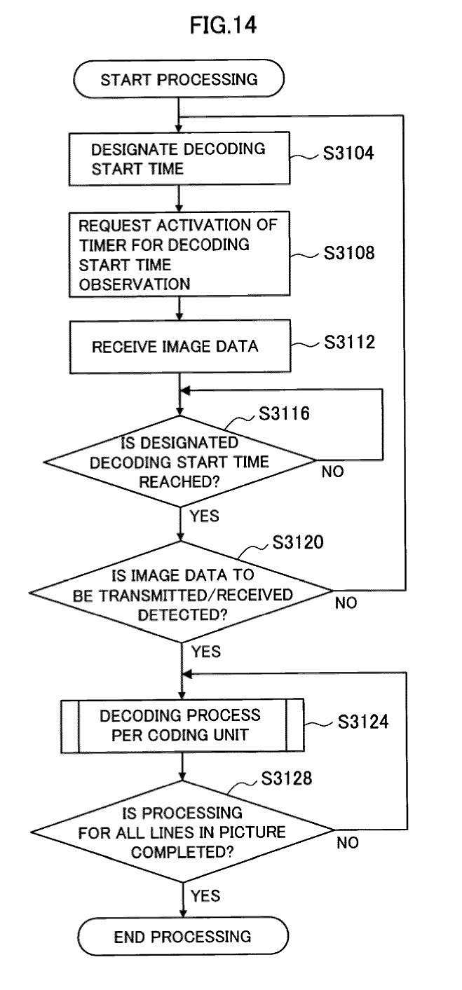

Next, the flow of transmission processing of image data by the transmitting apparatus 100a according to the present embodiment and reception processing by the receiving apparatus 300 will be described using FIG. 13 and FIG. 14.

FIG. 13 is a flow chart showing the flow of transmission processing of image data by the transmitting apparatus 100a.

Referring to FIG. 13, a transmission start instruction signal transmitted from the receiving apparatus 300 is first received by the image application management section 303 (S3004). The image application management section 303 acquires the transmission start time contained in the transmission start instruction signal.

Then, the image application management section 303 waits until the transmission start time comes (S3008) and outputs image data to the compression section 110 when the transmission start time comes. The compression section 110 encodes the output image data per the coding unit of N lines (N is equal to or greater than 1) in one field and outputs the encoded image data to the transmission memory section 112 (S3012). Subsequently, the image data is stored in the transmission memory section 112 in accordance with the communication path and the progress of transmission processing (S3016).

Subsequently, when the transmission timing comes, image data is output from the transmission memory section 112 to the communication section 104 to start generation of communication data containing image data (S3020). Then, communication data is transmitted toward the receiving apparatus 300 (S3024).

FIG. 14 is a flow chart showing the flow of reception processing of image data by the receiving apparatus 300.

Referring to FIG. 14, the decoding start time is first designated for the reception memory section 354 by the synchronization control section 390 (S3104). Here, the decoding start time can be designated, for example, by writing the decoding start time to a predetermined address in the storage section or outputting a signal to the reception memory section 354. At this point, a transmission start instruction signal is also transmitted from the synchronization control section 390 to the transmitting apparatus 100a.

Subsequently, timer activation to observe the time till the decoding start time (regarded as decoding start point in this embodiment) is requested by the reception memory section 354 (S3108).

Further, image data received from the transmitting apparatus 100a via the communication section 304 is sequentially delivered to the reception memory section 354 (S3112). Image data delivered here is stored till the decoding start time.

Then, when the decoding start time designated at S3104 comes (S3116), it is determined whether or not reception of image data to be transmitted/received is completed at that time (S3120). Here, if image data to be transmitted/received is not detected, processing returns to S3104 to readjust the transmission/reception timing of the image data.

On the other hand, if image data to be transmitted/received is detected at S3116, decoding processing per the coding unit is performed on the image data (S3124). The decoding processing in the coding unit here is processing similar to decoding processing in the coding unit according to the first embodiment described using FIG. 5.

Then, decoding processing in the coding unit is repeated until processing for all lines in a picture is completed (S3128) and reception processing ends when processing for all lines is completed.

The third embodiment of the present invention has been described above using FIG. 10 to FIG. 14. In the present embodiment, the receiving apparatus 300 includes the synchronization control section 390 that transmits a signal to designate the transmission start time of image data to the transmitting apparatus 100a or the transmitting apparatus 100b.

According to the configuration described above, in the communication system 30 in which a plurality of transmitting apparatuses is present per one receiving apparatus, the receiving apparatus 300 plays the role of a timing controller when a plurality of pieces of image data is managed or integrated on the receiving side so that the plurality of pieces of image data can be synchronized.

The synchronization control section 390 also designates a decoding start time having a time interval to absorb an influence of fluctuations of communication environment with respect to the transmission start time for the decoding start instruction section in the reception memory section 354. Then, the decoding start instruction section in the reception memory section 354 decides the decoding start point based on the designated decoding start time to instruct the start of decoding in the coding unit of image data. Accordingly, image data synchronously transmitted between transmitting apparatuses may steadily be decoded in synchronization while absorbing an influence of fluctuations of the communication environment and the like.

If the aforementioned line-based wavelet conversion is used as a line-based codec, which is common to the first to third embodiments described thus far, communication packets can be generated in units of sub-bands of line block, instead of in units of line blocks. In that case, for example, a storage area corresponding to the line block number or sub-band number acquired from the image header may be secured in the reception memory section 154, 254, or 354 to store image data decomposed into frequency components in units of sub-bands of line block.

At this point, if a sub-band is missing due to a transmission error or the like when, for example, decoding is performed in units of line blocks, dummy data may be inserted into the corresponding and subsequent sub-bands in a line block to perform normal decoding from the next line block.

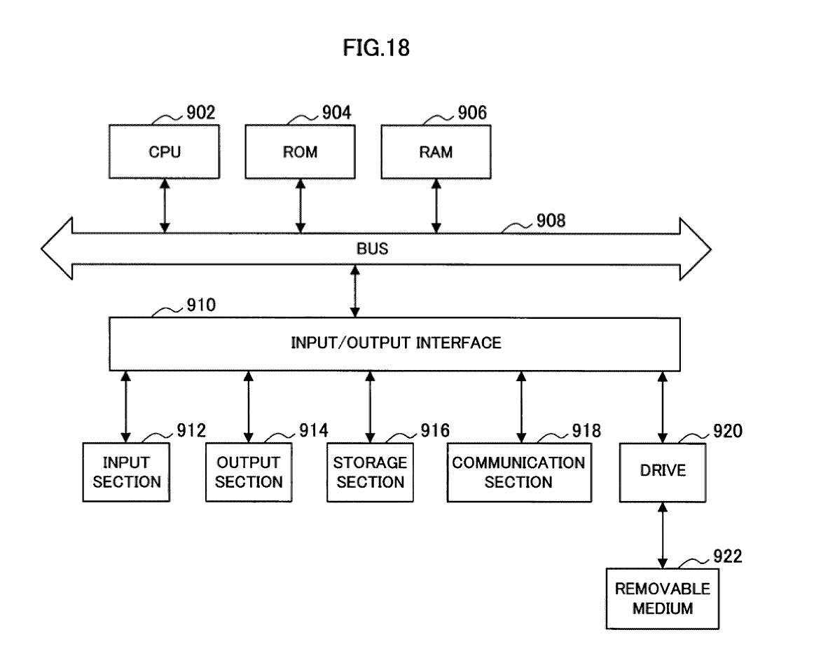

It does not matter whether a sequence of processing according to the first to third embodiments described herein is realized by hardware or software. When the sequence of processing is realized using software, a program constituting the software is executed by using a computer embedded in dedicated hardware or, for example, a general-purpose computer shown in FIG. 18.

In FIG. 18, a CPU (Central Processing Unit) 902 controls overall operations of a general-purpose computer. Data or a program which describes a portion of or all of a sequence of processing is stored in a ROM (Read Only Memory) 904. A program or data used by the CPU 902 for processing is temporarily stored in a RAM (Random Access Memory) 906.

The CPU 902, the ROM 904, and the RAM 906 are mutually connected via a bus 908. An input/output interface 910 is further connected to the bus 908.

The input/output interface 910 is an interface to connect the CPU 902, the ROM 904, and the RAM 906 to an input section 912, an output section 914, a storage section 916, a communication section 918, and a drive 920.

The input section 912 accepts instructions from a user or information input via an input device such as a button, switch, lever, mouse, or keyboard. The output section 914 outputs information to the user via a display device such as a CRT (Cathode Ray Tube), liquid crystal display, and OLED (Organic Light Emitting Diode) or a sound output device such as a speaker.

The storage section 916 is constituted, for example, by a hard disk drive or flash memory and stores programs, program data, image data and the like. The communication section 918 corresponds to the communication sections 104, 204, and 304 in the first to third embodiments respectively and performs communication processing via any network. The drive 920 is provided in a general-purpose computer when it is necessary and, for example, a removable media 922 is inserted into the drive 920.

When a sequence of processing according to the first to third embodiments described herein is realized by software, for example, a program stored in the ROM 904, the storage section 916, or the removable media 922 is read into the RAM 906 during execution and executed by the CPU 902.

It should be understood by those skilled in the art that various modifications, combinations, sub-combinations and alterations may occur depending on design requirements and other factors insofar as they are within the scope of the appended claims or the equivalents thereof.

For example, a reception memory section in the first to third embodiments may be arranged subsequent to a decoding section. In that case, a storage section in the reception memory section stores, instead of image data before being decoded, decoded image data in the coding unit. Then, a decoding start instruction section instructs output of decoded image data from the storage section to an image application management section, instead of decoding of image data, for example, according to a procedure shown in FIG. 5.

Two or more kinds of processing of reception processing (or decoding processing) according to the first to third embodiments may be performed while being switched. For example, a header may be caused to hold switching information for switching processing to be performed of processing according to the first to third embodiments or settings may be caused to be made to a terminal in advance. In such a case, a receiving apparatus can acquire the switching information from the header or terminal settings in advance, for example, at S1204 in FIG. 5, S2104 in FIG. 9, or S3112 in FIG. 14, which are steps to receive image data. Then, the receiving apparatus can switch the subsequent processing by selecting one piece of processing based on the acquired switching information.

A transmitting apparatus implementing only functions for transmission of image data among functions of the communication apparatus 100 or the communication apparatus 200 described in connection with the first embodiment or the second embodiment respectively may be constructed. Alternatively, a receiving apparatus implementing only functions for reception of image data may be implemented. Further, a communication system containing such a transmitting apparatus and a receiving apparatus may be constructed.

The present application contains subject matter related to that disclosed in Japanese Priority Patent Application JP 2008-129852 filed in the Japan Patent Office on May 16, 2008, the entire content of which is hereby incorporated by reference.

What is claimed is:

1. A receiving apparatus, comprising:
a header detection section that receives image data encoded per a coding unit corresponding to N (N is equal to or greater than 1) lines in one field and detects control information to decide a decoding start point of the image data from a header attached to the image data;
a storage section that stores the image data in each storage area assigned per the coding unit;
a decoding start instruction section that decides a decoding start point of the image data based on the control information detected by the header detection section and, after waiting till the decoding start point, instructs a start of decoding per the coding unit; and
a decoding section that decodes the image data stored in the storage section per the coding unit after the instruction to start decoding being received from the decoding start instruction section.

2. The receiving apparatus according to claim 1, wherein the header detection section includes a first header detection section that detects a first time stamp corresponding to a data transmission point from a communication header attached to the image data and a second header detection section that detects a second time stamp corresponding to a coding point from an image header attached to the image data.

3. The receiving apparatus according to claim 2, wherein the decoding start instruction section adjusts the decoding start point in accordance with a time difference between the first time stamp and the second time stamp detected by the header detection section.

4. The receiving apparatus according to claim 1, wherein the decoding start instruction section sequentially measures a permissible decoding time for each coding unit from the decoding start point to instruct a start of decoding per the coding unit each time the permissible decoding time passes.

5. The receiving apparatus according to claim 1, wherein if reception of image data to be decoded per the coding unit is not completed, the decoding start instruction section inserts dummy data instead of the image data whose reception is not completed.

6. The receiving apparatus according to claim 5, wherein the dummy data is image data of a previous picture or a picture prior to the previous picture in a line or line block identical to that of the image data to be decoded.

7. The receiving apparatus according to claim 4, wherein if image data to be decoded remains when the permissible decoding time per the coding unit ends, the decoding start instruction section makes the image data to be decoded deleted.

8. The receiving apparatus according to claim 1, wherein the decoding start instruction section decides a point when a predetermined time passes after control information indicating that a head of a picture has been recognized being output by the header detection section as the decoding start point.

9. The receiving apparatus according to claim 1, further comprising a synchronization control section that transmits a signal to designate a transmission start time of the image data to a source apparatus of the image data.

10. The receiving apparatus according to claim 9, wherein
the synchronization control section designates a decoding start time having a time interval to absorb fluctuations of a communication environment between the transmission start time and the decoding start time for the decoding start instruction section and
the decoding start instruction section decides the decoding start point based on the designated decoding start time.

11. The receiving apparatus according to claim 1, wherein
the header detection section includes a first header detection section that detects a first time stamp corresponding to a data transmission point from a communication header attached to the image data and a second header detection section that detects a second time stamp corresponding to a coding point from an image header attached to the image data and
the decoding start instruction section decides, based on switching information for switching processing to be performed, a point when a predetermined time passes after control information indicating that a head of a picture has been recognized being output by the header detection section as the decoding start point or adjusts the decoding start point in accordance with a time difference between the first time stamp and the second time stamp detected by the header detection section.

12. The receiving apparatus according to claim 1, further comprising:
a synchronization control section that transmits a signal to designate a transmission start time of the image data to a source apparatus of the image data and designates a decoding start time having a time interval to absorb fluctuations of a communication environment between the transmission start time and the decoding start time for the decoding start instruction section, wherein
the decoding start instruction section decides, based on switching information for switching processing to be performed, a point when a predetermined time passes after control information indicating that a head of a picture has been recognized being output by the header detection section as the decoding start point or decides the decoding start point based on the decoding start time designated by the synchronization control section.

13. The receiving apparatus according to claim 1, further comprising:
a synchronization control section that transmits a signal to designate a transmission start time of the image data to a source apparatus of the image data and designates a decoding start time having a time interval to absorb fluctuations of a communication environment between the transmission start time and the decoding start time for the decoding start instruction section, wherein
the header detection section includes a first header detection section that detects a first time stamp corresponding to a data transmission point from a communication header attached to the image data and a second header detection section that detects a second time stamp corresponding to a coding point from an image header attached to the image data and
the decoding start instruction section adjusts, based on switching information for switching processing to be performed, the decoding start point in accordance with a time difference between the first time stamp and the second time stamp detected by the header detection section or decides the decoding start point based on the decoding start time designated by the synchronization control section.

14. A receiving method, comprising the steps of:
receiving image data encoded per a coding unit corresponding to N (N is equal to or greater than 1) lines in one field;
detecting control information to decide a decoding start point of the image data from a header attached to the image data;
storing the image data in each storage area assigned per the coding unit;
waiting till the decoding start point of the image data decided based on the detected control information;
instructing a start of decoding per the coding unit; and
decoding the stored image data per the coding unit after the instruction to start decoding being received.

15. A program causing a computer that controls a receiving apparatus to function as the receiving apparatus, comprising:
a header detection section that receives image data encoded per a coding unit corresponding to N (N is equal to or greater than 1) lines in one field and detects control information to decide a decoding start point of the image data from a header attached to the image data;
a storage section that stores the image data in each storage area assigned per the coding unit;
a decoding start instruction section that decides a decoding start point of the image data based on the control information detected by the header detection section and, after waiting till the decoding start point, instructs a start of decoding per the coding unit; and
a decoding section that decodes the image data stored in the storage section per the coding unit after the instruction to start decoding being received from the decoding start instruction section.

16. A communication system comprising:
a transmitting apparatus including:
a compression section that encodes image data per a coding unit corresponding to N (N is equal to or greater than 1) lines in one field; and
a communication section that transmits the image data encoded per the coding unit, and
a receiving apparatus including:
a communication section that receives the image data encoded per the coding unit and transmitted from the transmitting apparatus;
a header detection section that detects control information to decide a decoding start point of the image data from a header attached to the image data received by the communication section;
a storage section that stores the image data in each storage area assigned per the coding unit;
a decoding start instruction section that decides a decoding start point of the image data based on the control information detected by the header detection section and, after waiting till the decoding start point, instructs a start of decoding per the coding unit; and
a decoding section that decodes the image data stored in the storage section per the coding unit after the instruction to start decoding being received from the decoding start instruction section.
